(19) United States
(12) Patent Application Publication
(10) Pub. No.: US 2025/0162010 A1
(43) Pub. Date: May 22, 2025

(54) METHOD FOR ACHIEVING REMEDIATION OF CHLORINATED ORGANIC POLLUTANT-CONTAMINATED SOIL AND REDUCTION OF METHANE EMISSION SYNCHRONOUSLY THROUGH MICROBIAL REGULATION

(71) Applicant: Zhejiang University, Hangzhou (CN)

(72) Inventors: Yan HE, Hangzhou (CN); Jie CHENG, Hangzhou (CN); Jianming XU, Hangzhou (CN)

(73) Assignee: Zhejiang University, Hangzhou (CN)

(21) Appl. No.: 18/948,577

(22) Filed: Nov. 15, 2024

(30) Foreign Application Priority Data
Nov. 22, 2023 (CN) 202311561073.3

(51) Int. Cl. B09C 1/10

(52) U.S. Cl. CPC B09C 1/10

(57) ABSTRACT

A method for achieving a remediation of a chlorinated organic pollutant (COP)-contaminated soil and a reduction of a methane emission synchronously through a microbial regulation is provided, including: in an anaerobic environment, adding at least one of electron donors, electron shuttles, and electron flow interference agents to the COP-contaminated soil to accurately and directionally regulate an electron transfer route, facilitating a COP reductive dechlorination mediated by indigenous microorganisms and meanwhile inhibiting a growth and a metabolism of methanogens synchronously. Electron donors are added as a carbon source to promote microbial growth and metabolism under anaerobic conditions, electron shuttles such as biochar are added to accelerate the transfer of electrons from the donor to the acceptor, and the electron flow interference agents such as a methanogenic inhibitor or a FeCl₃ solvent are added to regulate more electrons released from microbial respiratory metabolism to flow towards dechlorination process rather than methanogenesis process.

### CROSS REFERENCE TO THE RELATED APPLICATIONS

This application is based upon and claims priority to Chinese Patent Application No. 202311561073.3, filed on Nov. 22, 2023, the entire contents of which are incorporated herein by reference.

### TECHNICAL FIELD

The present disclosure belongs to the technical field of soil pollution remediation and in particular, relates to a method for achieving remediation of chlorinated organic pollutant-contaminated soil and reduction of methane emission synchronously by regulating the microbial-mediated electron transfer process.

### BACKGROUND

Chlorinated organic pollutant (COP) is an artificial organic compound containing chlorine atoms with hydrocarbon as the basic skeleton, and it has the properties of low solubility, high lipophilicity, and strong stability. COP is produced in large quantities throughout the country to meet the demand of social production and food supply. The utilization ratio of most COP is low. When COP is excessively disposed in the environment, it is recalcitrant in soil and sediment, easy to attach to the surface of aerosols and migrate over long distances on a global scale, and is bioaccumulative and biotoxic. Abiotic methods to dissipate COPs involve physical treatments such as mechanical separation and chemical ones that include oxidation, reduction, adsorption, and complexation, during which COPs are converted, reduced, and fixed in the soil matrix. However, these approaches usually result in harmful disruption of soil structure and function and would even destroy soil health. In addition, chemical-physical remediation is associated with high costs, technical challenges, and potential environmental risks, hindering the practical application. The microbial remediation is environmentally friendly, green, low cost, and does not damage soil structure and function, mainly including aerobic compost and anaerobic reductive dechlorination. Under aerobic conditions, the use of artificial additives such as livestock manure, compost excipients, and waste from agriculture and forestry to promote COP biodegradation in soil mounds is called biological compost. However, the strong toxicity and high concentration of COPs pose significant challenges for complete biodegradation. The accumulation of intermediate products often accompanies it, which needs a prolonged repair duration exceeding six months. Under the anaerobic environment, the microbial remediation of COPs by the functional consortium through reductive dichlorination is a more promising strategy, which is mediated by microbial respiratory metabolism. In this process, COPs are the terminal electron acceptors, while H₂ or several small molecular substances act as electron donors. COPs are gradually dechlorinated to some non-toxic compounds such as alkanes and olefins. It has numerous advantages such as high efficiency, complete degradation, no secondary pollutant accumulation, and being environmentally friendly.

In the anaerobic environment, the microbial remediation of COPs is usually accompanied by a large amount of methane emission, triggering an ecological risk of global warming. Among the core degrading consortium, methanogens undergo complex metabolic processes, utilizing small molecular compounds such as formate, acetate, and ethanol to capture electrons, in which CO₂ is reduced to CH₄. As an important greenhouse gas, CH₄ has a global warming potential (GWP) that is 86 times higher than that of carbon dioxide over a 20-year timeframe, making its emission a critical environmental concern during COP remediation.

A relevance is revealed between COP reductive dichlorination and methanogenesis, based on which the direction and rate of electron transfer play a crucial role in determining the extent and rate of both processes. The electron transfer mechanisms include three key steps: first, microbial oxidation of organic matter to provide electron donors; second, electron transfer via electron shuttles; and third, electron acceptors, including COPs and carbon dioxide, to receive electrons and undergo reduction. Based on this understanding, the present disclosure aims at the full route of microbial-mediated electron transfer to design targeted regulations to control the electron transfer among electron donor, electron shuttle, and electron acceptor. It offers a cleaner, greener, more efficient, and more comprehensive solution to synchronously achieve COP remediation and suppress greenhouse gas CH₄ emissions in the COP-contaminated soil according to the “pollution reduction-carbon reduction” win-win strategy.

### SUMMARY

An objective of the present disclosure is to address the ecological risk caused by the increased greenhouse gas emissions associated with current microbial remediation technologies for chlorinated organic pollutant (COP)-contaminated soil. It aims to provide an innovative approach that leverages microbes to remediate COP-contaminated soil and mitigate methane emissions simultaneously. By regulating the microbial electron transfer process, the present disclosure improves the efficiency of indigenous microbial COP degradation while minimizing the risk of global warming due to elevated methane emissions during the remediation process. The present disclosure provides scientific support for synchronously achieving pollution remediation and carbon reduction.

The specific technical solutions adopted by the present disclosure are as follows.

The present disclosure provides a method for achieving remediation of chlorinated organic pollutant-contaminated soil and reduction of methane emission synchronously through microbial regulation in an anaerobic environment, involving an addition of at least one of the following: electron donors, electron shuttles, and electron flow interference agents to the soil to accurately and directionally regulate the electron transfer route, facilitating COP reductive dechlorination that is mediated by indigenous microorganisms and also inhibiting the growth and metabolism of methanogens synchronously, thereby achieving a win-win outcome regarding COP remediation and suppressed methane emission in the COP-contaminated soil.

As a preferred option, as a carbon source, the electron donors adopt sodium formate solvent with a concentration of 1-10 mmol/L, and an added amount of sodium formate is 1.0% of the soil mass.

As a preferred option, the electron shuttles adopt biochar, and an added amount of biochar accounts for 1.0%-2.0% of the soil mass.

Specifically, a grain size of biochar is less than 150 mesh (70 μm).

Specifically, the biochar as an electron shuttle is obtained by calcining wheat straw in a muffle furnace at 500° C. for 2 h and passing through a 150-mesh sieve.

As a preferred option, the electron flow interference agents adopt a methanogenic inhibitor with a concentration of 10-20 mmol/L, or FeCl₃ solvent with a concentration of 0.1-1.0 mmol/L, when adding the methanogenic inhibitor, an added amount of the methanogenic inhibitor is 1.0% of the soil mass, and when adding FeCl₃ solvent, an added amount of the FeCl₃ solvent is 0.1% of the soil mass.

Further, the methanogenic inhibitor is sodium 2-bromoethanesulfonate solvent (BES).

As a preferred option, a concentration of the sodium formate solvent is 10 mmol/L, a concentration of the BES solvent is 20 mmol/L, and a concentration of FeCl₃ solvent is 0.1 mmol/L.

As a preferred option, specific steps of the method are as follows:
S1. excavating COP-contaminated soil to be processed from an original site to the surface, and transporting the COP-contaminated soil to an open area;
S2. naturally air-drying and sieving the excavated COP-contaminated soil to form COP-contaminated fine particulate soil;
S3. transferring the COP-contaminated fine particulate soil to a remediation area equipped with anti-seepage measures and spreading the COP-contaminated fine particulate soil evenly and stacking;
S4. adding sterilized water to the COP-contaminated fine particulate soil according to a soil-water volume ratio of 1:2, mixing evenly, and covering the surface of the soil with a sunshade plastic film to maintain anaerobic conditions in the dark;
S5. adding at least one of the following: electron donors, electron shuttles, and electron flow interference agents to the treated COP-contaminated soil suspension and mixing thoroughly; and
S6. sitting the treated COP-contaminated soil suspension under dark anaerobic conditions, covering the surface of the soil with a sunshade plastic film, stirring intermittently, and ultimately achieving complete degradation of COPs in an anaerobic environment while simultaneously mitigating greenhouse gas methane emission.

Further, in step S2, soil moisture is reduced to below 10% after natural air-drying, and a soil particle size is less than 20 mm after screening and crushing.

Further, in step S3, the soil is spread evenly and stacked with a thickness of 40-70 cm.

Further, in step S4, an anaerobic curing period lasts for 28-30 days; and in step S6, an anaerobic curing period is 15-30 days.

Further, the COP refers specifically to the soil polluted by pentachlorophenol and/or γ-hexachlorocyclohexane.

Further, in step S4, the sterilized water is prepared by boiling the deionized water at 100° C. for 20 min.

Compared with the prior art, the present disclosure has the following beneficial effects.

The traditional microbial remediation approaches for COP-contaminated soil often require external introduction of microbial agents, a long remediation cycle, incomplete decontamination, complex remediation steps, and stringent conditions. Additionally, it also poses secondary environmental pollution, such as the excessive emission of greenhouse gas methane under anaerobic conditions. The present disclosure overcomes the limitations of conventional approaches, which tend to focus on a singular process. By considering the entire electron transfer pathway, the present disclosure addresses the ecological risk of greenhouse gas emission caused by COP remediation in the anaerobic environment. The proposed method involves precisely targeted regulation strategies for each electron transfer step, enabling indigenous microorganisms to reduce COP and methane emission synergistically. Sodium formate solvent is added as a carbon source to promote microbial growth and metabolism, thereby releasing sufficient electrons. Biochar as an electron shuttle is added to accelerate the transfer of electrons from the donor to the acceptor. An electron flow interference agent such as methanogenic inhibitor BES solvent or FeCl₃ solvent is added to reduce the electrons flowing towards CO₂, thereby enhancing COP remediation and also reducing methane production synchronously. The entire remediation process eliminates the introduction of exogenous microbial agents, instead, indigenous dechlorinating microorganisms, both obligate and facultative dechlorinators, proliferate and thrive throughout the remediation. The remediation process is environmentally friendly, avoids secondary pollution, and ensures thorough dissipation. Therefore, by precisely regulating the direction and flow of electrons at each stage of the electron transfer route, the present disclosure improves COP remediation while mitigating the emission of greenhouse gases, thereby reducing the ecological risk of microbial remediation. The present disclosure offers a more efficient, cleaner and cost-effective solution for the concurrent reduction of COP remediation and methane emission in COP-contaminated soils.

### BRIEF DESCRIPTION OF THE DRAWINGS

FIG. 1 is a process flow diagram of remediation of COP-contaminated soil and synchronous reduction of methane emission of the present disclosure; and

FIG. 2 is an effect diagram for embodiments of remediation of COP-contaminated soil and synchronous reduction of methane emission of the present disclosure.

### DETAILED DESCRIPTION OF THE EMBODIMENTS

In the following, the present disclosure is further elaborated and explained in combination with the attached drawings and specific embodiments. The technical characteristics of each embodiment in the present disclosure may be combined without conflicting with each other.

The present disclosure provides a method for achieving remediation of chlorinated organic pollutant (COP)-contaminated soil and reduction of methane emission synchronously through microbial regulation. In an anaerobic environment, the method involves an addition of at least one of the following: electron donors, electron shuttles, and electron flow interference agents to the soil to accurately and directionally regulate the electron transfer route, which facilitates COP reductive dechlorination that is mediated by indigenous microorganisms and also inhibits the growth and metabolism of methanogens synchronously, to achieve a win-win outcome regarding COP remediation and suppressed methane emission.

In the practical application, as a carbon source, the electron donors adopt sodium formate solvent with a concentration of 1-10 mmol/L, and an added amount of sodium formate is 1.0% of the soil mass. The electron shuttles adopt biochar, and an added amount of biochar accounts for 1.0%-2.0% of the soil mass. The electron flow interference agents adopt a methanogenic inhibitor with a concentration of 10-20 mmol/L, or FeCl₃ solvent with a concentration of 0.1-1.0 mmol/L, when adding the methanogenic inhibitor, an added amount of the methanogenic inhibitor is 1.0% of the soil mass, and when adding the FeCl₃ solvent, an added amount of the FeCl₃ solvent is 0.1% of the soil mass. The methanogenic inhibitor is sodium 2-bromoethanesulfonate solvent (BES).

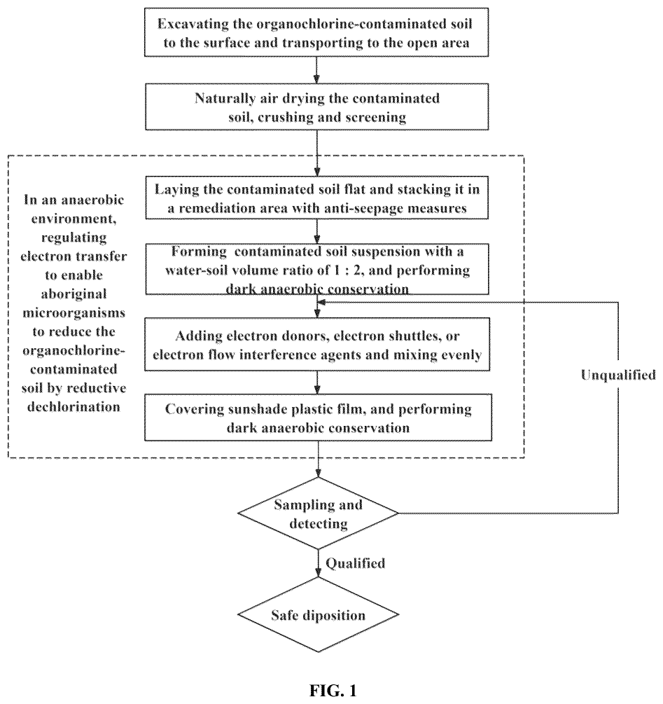

As shown in FIG. 1, steps of the above method are as follows:

S2. COP-contaminated soil to be processed is excavated from an original site to the surface and transported to an open area.

Specifically, the COP refers to the soil polluted by pentachlorophenol and/or γ-hexachlorocyclohexane.

S2. The excavated COP-contaminated soil is naturally air-dried and sieved to form COP-contaminated fine particulate soil

Specifically, soil moisture is reduced to below 10% after natural air-drying, and a soil particle size is less than 20 mm after screening and crushing.

S3. The COP-contaminated fine particulate soil is transferred to a remediation area equipped with anti-seepage measures, spread evenly and stacked.

Specifically, the soil is spread and stacked with a thickness of 40-70 cm.

S4. Sterilized water is added to the COP-contaminated fine particulate soil according to a soil-water volume ratio of 1:2, the soil is mixed evenly, and the surface of the soil is covered with a sunshade plastic film to maintain anaerobic conditions in the dark.

Specifically, an anaerobic curing period lasts for 28-30 days, and the sterilized water is prepared by boiling the deionized water at 100° C. for 20 min.

S5. At least one of the following: electron donors, electron shuttles, and electron flow interference agents is added to the treated COP-contaminated soil suspension and mixed thoroughly.

Specifically, an anaerobic curing period is 15-30 days.

S6. The treated COP-contaminated soil suspension is sat under dark anaerobic conditions, the surface of the soil is covered with a sunshade plastic film, and the soil is stirred intermittently, ultimately achieving complete degradation of COPs in an anaerobic environment while simultaneously mitigating greenhouse gas methane emission.

The following will explain the steps and effects of the method of the present disclosure through the embodiments and the control examples.

### Embodiment 1

For an area of COP-contaminated soil, the results showed that one pollutant was mainly pentachlorophenol, a pollution concentration was 30-50 mg/kg, and the pollution area was concentrated in the 0-20 cm surface soil layer.

The present embodiment took sodium formate as an electron donor to achieve remediation of the COP-contaminated soil and reduction of methane emission synchronously through microbial regulation. The method was implemented through excavation and transportation of raw soil, treatment of raw soil, soil curing and soil remediation, specifically, as follows:

### 1) Excavation and Transportation of Raw Soil

The COP-contaminated soil was excavated from an original site to the surface by an excavator and then transported to a temporary storage area by an agricultural transport vehicle for subsequent treatment.

### 2) Treatment of Raw Soil

After the contaminated soil was in-situ naturally air-dried in the temporary storage area, the COP-contaminated soil was transported to a crushing and screening machine with a belt conveyor, the stones were removed from the COP-contaminated soil, and the COP-contaminated soil was crushed and screened to form COP-contaminated fine particulate soil with a soil particle size of less than 20 mm, the COP-contaminated fine particulate soil was evenly tossed with a turning machine, then transported to a remediation area equipped with an anti-seepage film, spread evenly and stacked.

### 3) Soil Curing

According to a soil-water volume ratio of 1:2, the sterilized water was added to the remediation area, and the COP-contaminated fine particulate soil suspension was mixed evenly with a stirring paddle 5 times, covered with a sunshade plastic film and maintained in the dark for 28 days;

### 4) Soil Remediation

1 mmol/L sodium formate solvent was added, and a total spraying amount of the sodium formate solvent was 0.5% of the soil mass, after stirring 5 times with the stirring paddle, a sunshade plastic film was covered to create a dark anaerobic environment; and the soil was sat for curing for 28 days, stirred once every 5 days during the curing process. During the curing process, the content of pentachlorophenol and methane was regularly sampled and detected.

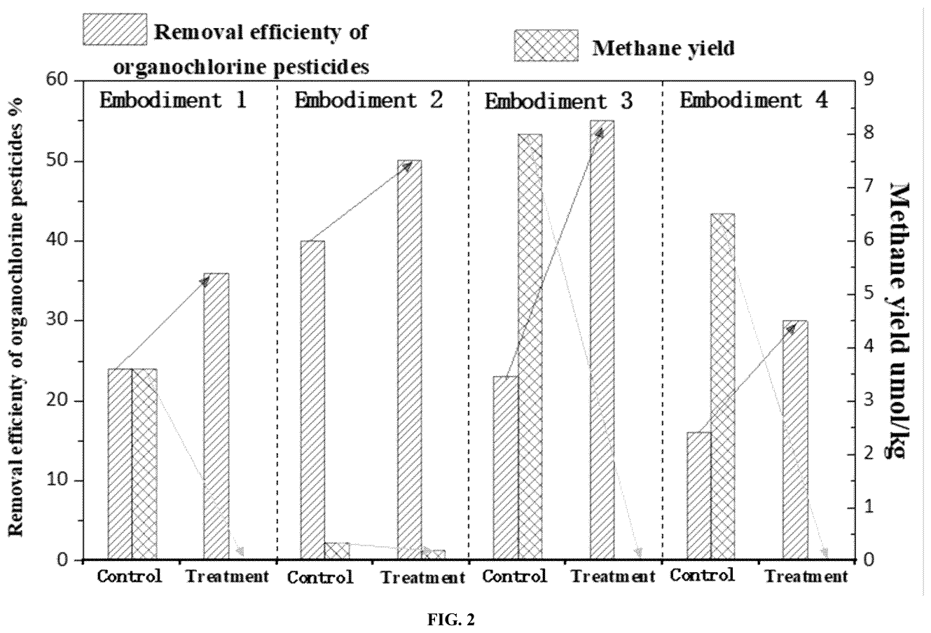

A control group without sodium formate solvent was sampled by the same method (that was, steps 1)-3) were the same as those in the present embodiment, and the only difference was that the sodium formate solvent was not added in Step 4)). The results showed that the removal efficiency of pentachlorophenol was 36% and the methane emission was 0 μmol/kg in the treatment with sodium formate solvent. Compared with the control group without sodium formate, the removal efficiency of pentachlorophenol was increased by 33% and the methane emission was decreased by 100%. The effect of COP remediation and synchronous reduction of methane emission through microbial regulation in the present embodiment was shown in FIG. 2.

### Embodiment 2

In an area of COP-contaminated soil, the results showed that one pollutant was mainly γ-hexachlorocyclohexane, a pollution concentration was 30-60 mg/kg, and the pollution area was concentrated in the 0-20 cm surface soil layer.

The present embodiment took biochar as an electron shuttle to achieve remediation of the COP-contaminated soil and reduction of methane emission synchronously through microbial regulation. The method was implemented through excavation and transportation of raw soil, treatment of raw soil, soil curing, and soil remediation, wherein the first three steps were consistent with Embodiment 1, which were not repeated here, and the following was only a detailed description of step 4) soil remediation.

### 4) Soil Remediation

Biochar was added, a particle size of the biochar was 100 mesh, which was prepared by calcining wheat straw in a muffle furnace at 500° C. for 2 h and passing through a 100-mesh sieve, an added amount of the biochar was 1% of the soil mass, the COP-contaminated fine particulate soil suspension and the biochar were mixed evenly with a stirring paddle 5 times, a sunshade plastic film was covered to create a dark anaerobic environment; and the COP-contaminated soil was sat for curing for 28 days, and during the curing process, the biochar and COP-contaminated soil suspension were mixed evenly by intermittent use of a stirring paddle for 6 times.

A control group without the biochar was sampled by the same method (that was steps 1)-3) were the same as those in the present embodiment, and the only difference was that the biochar was not added in Step 4)). In the step of soil remediation, the content for γ-hexachlorocyclohexane and methane was regularly sampled and detected during the curing process. The results showed that the removal efficiency of γ-hexachlorocyclohexane was 50% and the methane emission was 0.5 μmol/kg in the treatment with biochar. Compared with the control group without the biochar, the removal efficiency of γ-hexachlorocyclohexane was increased by 20% and the methane emission was decreased by 70%. The effect of COP remediation and synchronous reduction of methane emission through microbial regulation in the present embodiment was shown in FIG. 2.

### Embodiment 3

In the present embodiment, a selected COP-contaminated soil area contaminated by γ-hexachlorocyclohexane was the same as that in Embodiment 2. In the COP-contaminated soil, one pollutant was mainly γ-hexachlorocyclohexane, and a pollution concentration was 38 mg/kg.

A method for achieving remediation of the COP-contaminated soil and reduction of methane emission synchronously through microbial regulation by regulating the electron transfer process provided by the present embodiment was implemented through the following steps: excavation and transportation of raw soil, treatment of raw soil, soil curing, and soil remediation. Wherein the steps of excavation and transportation of raw soil, treatment of raw soil, and soil curing were the same with Embodiment 1, which were not repeated here, and the following was only a detailed description of step 4) soil remediation.

20 mmol/L BES solvent was sprayed onto the COP-contaminated fine particulate soil suspension, a total spraying amount of BES solvent was 0.5% of soil mass, the COP-contaminated soil suspension and BES solvent were mixed evenly with a stirring paddle 5 times, a sunshade plastic film was covered to create a dark anaerobic environment; and the soil was sat for curing for 28 days and stirred once every 5 days with the stirring paddle. During the curing process, the content for γ-hexachlorocyclohexane and methane was regularly sampled and detected.

A control group without BES solvent was sampled by the same method (that was steps 1)-3) were the same as those in the present embodiment, and the only difference was that BES solvent was not added in Step 4)). The results showed that the removal efficiency of γ-hexachlorocyclohexane was 55% and the methane emission was 0 μmol/kg in the treatment with BES solvent. Compared with the control group without BES solvent, the removal efficiency of γ-hexachlorocyclohexane was increased by 57% and the methane emission was decreased by 100%. The effect of COP remediation and synchronous reduction of methane emission through microbial regulation in the present embodiment was shown in FIG. 2.

### Embodiment 4

In the present embodiment, a selected soil area contaminated by γ-hexachlorocyclohexane was the same as that in Embodiment 2. One pollutant was mainly γ-hexachlorocyclohexane, and a pollution concentration was 43 mg/kg.

A method for achieving remediation of COP-contaminated soil and reduction of methane emission synchronously through microbial regulation by regulating the electron transfer process provided by the present embodiment was implemented through the following steps: excavation and transportation of raw soil, treatment of raw soil, soil curing, and soil remediation. Wherein the steps of excavation and transportation of raw soil, treatment of raw soil, and soil curing were the same with Embodiment 1, which was not repeated here, and the following was only a detailed description of step 4) soil remediation.

In the step of the soil remediation, sodium formate solvent, biochar and FeCl₃ solvent were added to the COP-contaminated fine particulate soil suspension, a concentration of the sodium formate solvent was 1.2 mmol/L, and a particle size of the biochar was 100 mesh, and the biochar was prepared by calcining wheat straw in a muffle furnace at 500° C. for 2 h and passing through a 100-mesh sieve, an added amount of the biochar was 1% of the soil mass, and an added concentration of FeCl₃ solvent was 0.1 mmol/L, the COP-contaminated soil suspension and the biochar were mixed evenly with a stirring paddle 5 times, a sunshade plastic film was covered to create a dark anaerobic environment; and the soil was sat for curing for 15 days, and during the curing process, the biochar and the COP-contaminated soil suspension were mixed evenly by intermittent use of a stirring paddle for 3 times.

A control group without sodium formate solvent, biochar and FeCl₃ solvent was sampled by the same method. In the step of soil remediation, the content of γ-hexachlorocyclohexane and methane was regularly sampled and detected during the curing process. The results showed that the removal efficiency of γ-hexachlorocyclohexane was 30% and the methane emission was 0 mol/kg in the treatment with sodium formate solvent, biochar and FeCl₃ solvent. Compared with the control group, the removal efficiency of γ-hexachlorocyclohexane was increased by 53%, and the methane emission was decreased by 100%. The effect of COP remediation and synchronous reduction of methane emission through microbial regulation in the present embodiment was shown in FIG. 2.

In addition to the above embodiments, the present disclosure tested a variety of permutation and combination solvents of electron donors, electron shuttles, and electron flow interference agents with single addition, pairwise combination, and all addition, the electron donors used included sodium formate solvent, sodium acetate solvent, lactic acid solvent and pyruvate solvent; the electron shuttles used included biochar, zero-valent iron nanoparticle, and zero-valent iron nanoparticle-modified biochar, and the electron flow interference agents used included a methanogenic inhibitor, FeCl₃ solvent, and a sulfate reduction inhibitor (sodium molybdate solvent). For different types of paddy soil, after several experiments, the optimal regulation methods for COP remediation and synchronous reduction of methane emission were designed, as shown in Table 1.

TABLE 1

| | | Optimal | |
|---|---|---|---|
| Applicable soil | | implementation | |
| type | Type of COP | solution | Effective Benefit |
| Paddy fields | γ-hexachloro- | Electron shuttle | The removal |
| with high | cyclohexane | biochar | efficiency of COP |
| methanogenic | | | was increased by |
| activity | | | 1.2 times, and the |
| | | | methane emission |
| | | | was reduced by |
| | | | 1.3 times. |
| Iron-rich paddy | pentachloro- | Electron donor | The removal |
| fields in the | phenol | acetic acid and | efficiency of COP |
| south | | electron shuttle | was increased by |
| | | zero-valent iron | 1.7 times, and the |
| | | nanoparticle | methane emission |
| | | | was reduced by |
| | | | 2.6 times. |
| Strong | pentachloro- | Electron flow | The removal |
| reductive | phenol | interference | efficiency of COP |
| paddy field | | agent sodium | was increased by |
| | | molybdate solvent | 1.5 times, and the |
| | | | methane emission |
| | | | was reduced by |
| | | | 1.6 times. |

The present disclosure proposes optimal precisely targeted regulation strategies according to each stage of the entire process of electron transfer: electron donors are added as a carbon source to promote microbial growth and metabolism under anaerobic conditions, electron shuttles such as biochar are added to accelerate the transfer of electrons from the donor to the acceptor, and the electron flow interference agents such as a methanogenic inhibitor or FeCl₃ solvent are added to regulate more electrons released by microbial anaerobic respiration metabolism to flow towards dechlorination process rather than methanogenesis process, thereby achieving efficient degradation of COPs while simultaneously mitigating greenhouse gas methane emission. Compared with remediation approaches for COP-contaminated soil, the present disclosure has the advantages of synchronous reduction of pollution and carbon emission, simple operation, more thorough remediation, ecological friendliness, and low cost, which can be applied to the remediation of COP-contaminated soil with low and medium COP concentrations.

The embodiments described above are only a preferred solution of the present disclosure, but they are not intended to limit the present disclosure. For those of ordinary skill in the art, various changes and variants can be made without deviating from the spirit and scope of the present disclosure. Therefore, any technical solution obtained by equivalent substitution or equivalent transformation falls within the protection range of the present disclosure.

What is claimed is:

1. A method for achieving a remediation of a chlorinated organic pollutant (COP)-contaminated soil and a reduction of a methane emission synchronously through a microbial regulation, comprising: in an anaerobic environment, adding at least one of electron donors, electron shuttles, and electron flow interference agents to the COP-contaminated soil to accurately and directionally regulate an electron transfer route, facilitating a COP reductive dechlorination mediated by indigenous microorganisms and meanwhile inhibiting a growth and a metabolism of methanogens synchronously, thereby achieving a win-win outcome regarding a COP remediation and a suppressed methane emission in the COP-contaminated soil; and
wherein steps of the method are as follows:
s1: excavating a COP-contaminated soil to be processed to a surface, and transporting the COP-contaminated soil to be processed to an open area;
s2: naturally air-drying and sieving an excavated COP-contaminated soil to form a COP-contaminated fine particulate soil;
s3: transferring the COP-contaminated fine particulate soil to a remediation area equipped with anti-seepage measures, and spreading the COP-contaminated fine particulate soil evenly and stacking;
s4: adding sterilized water to the COP-contaminated fine particulate soil according to a soil-water volume ratio of 1:2, mixing evenly, and covering a surface of the COP-contaminated fine particulate soil with a first sunshade plastic film to maintain anaerobic conditions in a dark;
s5: adding at least one of the electron donors, the electron shuttles, and the electron flow interference agents to a treated COP-contaminated soil suspension and mixing thoroughly;
s6: sitting a mixed COP-contaminated soil suspension under dark anaerobic conditions, covering a surface of the mixed COP-contaminated soil suspension with a second sunshade plastic film, stirring intermittently, and ultimately achieving a complete degradation of COPs in the anaerobic environment while simultaneously mitigating a greenhouse gas methane emission;
wherein as a carbon source, the electron donors adopt a sodium formate solvent with a concentration of 1-10 mmol/L, and an added amount of the sodium formate solvent is 1.0% of a soil mass; and
the electron shuttles adopt biochar, and an added amount of the biochar accounts for 1.0%-2.0% of the soil mass.

2. The method for achieving the remediation of the COP-contaminated soil and the reduction of the methane emission synchronously through the microbial regulation according to claim 1, wherein the electron flow interference agents adopt a methanogenic inhibitor with a concentration of 10-20 mmol/L, or a FeCl₃ solvent with a concentration of 0.1-1.0 mmol/L, when adding the methanogenic inhibitor, an added amount of the methanogenic inhibitor is 1.0% of the soil mass, and when adding the FeCl₃ solvent, an added amount of the FeCl₃ solvent is 0.1% of the soil mass.

3. The method for achieving the remediation of the COP-contaminated soil and the reduction of the methane emission synchronously through the microbial regulation according to claim 2, wherein the methanogenic inhibitor is a sodium 2-bromoethanesulfonate solvent.

4. The method for achieving the remediation of the COP-contaminated soil and the reduction of the methane emission synchronously through the microbial regulation according to claim 1, wherein in the step s2, a soil moisture of the COP-contaminated fine particulate soil is reduced to below 10% after being naturally air-dried, and a soil particle size of the COP-contaminated fine particulate soil is less than 20 mm after being sieved.

5. The method for achieving the remediation of the COP-contaminated soil and the reduction of the methane emission synchronously through the microbial regulation according to claim 1, wherein in the step s3, the COP-contaminated fine particulate soil is spread evenly and stacked with a thickness of 40-70 cm.

6. The method for achieving the remediation of the COP-contaminated soil and the reduction of the methane emission synchronously through the microbial regulation according to claim 1, wherein in the step s4, an anaerobic curing period lasts for 28-30 days; and in the step s6, an anaerobic curing period is 15-30 days.

7. The method for achieving the remediation of the COP-contaminated soil and the reduction of the methane emission synchronously through the microbial regulation according to claim 1, wherein the COPs are a soil polluted by pentachlorophenol and/or γ-hexachlorocyclohexane.
